(19) United States
(12) Patent Application Publication
(10) Pub. No.: US 2014/0342240 A1
(43) Pub. Date: Nov. 20, 2014

(54) Fluorinated phosphazenes for use as electrolyte additives and co-solvents in lithium ion batteries

(71) Applicants: Mason Kurt Harrup, Idaho Falls, ID (US); Harry Whittier Rollins, Idaho Falls, ID (US); Kevin Leslie Gering, Idaho Falls, ID (US); Michael Timothy Benson, Idaho Falls, ID (US)

(72) Inventors: Mason Kurt Harrup, Idaho Falls, ID (US); Harry Whittier Rollins, Idaho Falls, ID (US); Kevin Leslie Gering, Idaho Falls, ID (US); Michael Timothy Benson, Idaho Falls, ID (US)

(21) Appl. No.: 14/120,282

(22) Filed: May 14, 2014

Related U.S. Application Data
(60) Provisional application No. 61/823,151, filed on May 14, 2013.

(51) Int. Cl. H01M 10/0567; H01M 10/0525

(52) U.S. Cl. CPC H01M 10/0567; H01M 10/0525
USPC 429/326; 429/188; 429/341; 429/342; 429/200

(57) ABSTRACT

An electrolyte solution for use in a battery includes at least: an ionizable salt; at least one organic solvent; and at least one cyclic phosphazene compound.

### STATEMENT REGARDING FEDERALLY SPONSORED RESEARCH OR DEVELOPMENT

This invention was made with United States Government support under DE-AC07-051D14517 awarded by the United States Department of Energy. The United States Government has certain rights in the invention.

### FIELD

The present invention relates generally to additives and co-solvents for stabilizing electrolyte solutions, and in a particular though non-limiting embodiment to a fluorinated, phosphazene-based compound for stabilizing organic electrolyte solutions in lithium ion batteries, having improved safety and stability characteristics throughout the lifetime of a battery in which the additive is encapsulated.

### BACKGROUND

Lithium ion batteries (“LIBs”) are commonly used in a variety of consumer electronics, including cellular phones, computers, and camcorders. Recently, LIBs have been gaining popularity in other industries, including military, electric vehicle, aerospace, and oil and gas exploration, production, and transportation applications.

All batteries include an anode, cathode, and an ion carrier electrolyte solution or polymer that transports ions between the electrodes while the battery is charging or discharging. The electrolyte solution commonly includes an electrolyte and an organic carbonate solvent (which often is a mixture of organic carbonates).

The most common commercial electrolyte used for lithium-ion batteries is lithium hexafluorophosphate (LiPF₆), but lithium tetrafluoroborate (LiBF₄) and lithium perchlorate (LiClO₄) are also commonly used. 1.2 M LiPF₆ in ethylene carbonate (EC): diethyl carbonate (DEC) and 1.2 M LiPF₆ in EC: ethyl-methyl carbonate (EMC) are organic electrolyte solutions commonly used in the battery industry.

A typical solvent/electrolyte system in a commercial lithium ion battery contains a very high lithium concentration and low viscosity, thereby providing a good environment for ion transport and effective battery function.

These electrolyte blends are highly volatile and highly flammable, with typical flash points of about 30° C. or less. This presents serious safety concerns, especially when utilized in large format cells or when the cells come under undo stress or physical damage. Furthermore, reliance upon organic carbonates renders the electrolyte solution electrochemically unstable within desired operational windows. Unexpected fires and explosions have resulted from reliance upon the organic carbonates.

For example, lithium ions are transported during the charging or discharging process of the battery, resulting in a release of thermal energy. If the battery is under high demand, the resulting heat can be considerable. The vapor pressure of the solvent system increases as the temperature in the battery increases. If the thermal release is greater than the battery's natural cooling, the pressure exceeds the structural limits of the battery case, leading to rupture. The hot vapor mixes with oxygen in the air, and when an ignition source is present, a fire results.

The safety of lithium-ion batteries is coming under increased scrutiny as they are being adopted for large format applications, especially in the vehicle transportation industry and for grid-scale energy storage. The primary short comings of lithium-ion batteries are the flammability of the liquid electrolyte solution and sensitivity to high voltage and elevated temperatures.

There is, therefore, a long-standing yet unmet need for improved electrolyte solutions for use in lithium ion batteries which have an improved safety profile while still maintaining or improving the battery's performance. There is a further unmet need for methods of manufacturing the improved electrolyte solutions.

### SUMMARY

An electrolyte solution for use in a battery, including at least: an ionizable salt; at least one organic solvent; and at least one cyclic phosphazene compound.

### BRIEF DESCRIPTION OF THE DRAWINGS

For a further understanding of the nature, objects, and advantages of the present invention, reference should be had to the followed description, read in conjunction with the following drawings, wherein like reference numerals denote like elements and wherein:

FIG. 1 shows a structure according to an example embodiment of a compound suitable for use as an additive or co-solvent for a battery's electrolyte solution.

FIGS. 2A and 2B are graphs, showing the flash points of electrolyte solutions as a function of phosphazene loading in A) 1:1 EC:DEC (weight: weight) with 1.0 M LiPF₆ and in B) 1:2 EC:EMC (volume: volume) with 1.2 M LiPF₆, compared to the baseline electrolyte solutions, according to example embodiments.

FIGS. 3A and 3B are graphs, showing the vapor pressures of electrolyte solutions containing 20 wt % of the phosphazene additives FM2, FM3, and FM4, in A) 1:1 EC:DEC with 1.0 M LiPF₆ and FM1, FM2, FM3, and FM4, in B) 1:2 EC:EMC with 1.2 M LiPF₆ compared to the baseline electrolyte solution, according to example embodiments.

FIGS. 4A and 4B are graphs, showing the vapor pressures for 20 wt % phosphazene FM1, FM2, FM3, and FM4, in baseline phosphazene solution B at 30° C. as a function of: A) mole fraction EMC and B) mole fraction of ⁻OCH₂CF₃.

FIG. 5 is a graph, showing the voltamogram of 20 wt % phosphazene additives, 80 wt % 1:4 EC:EMC blends with overall 1.2 M LiPF₆.

FIGS. 6A and 6B are graphs, showing the average initial discharge capacities for cells at different rates in A) 1:1 EC:DEC with 1.0 M LiPF₆ and in B) 1:2 EC:EMC with 1.2 M LiPF₆ compared to the baseline electrolyte solutions.

FIGS. 7A and 7B are graphs, showing the discharge cycle capacities as a function of cycle number for cells with 20 wt % of the phosphazene additives FM2 and FM3 in A) 1:1 EC:DEC with 1.0 M LiPF₆ and FM2, FM3, and FM4 in B) 1:2 EC:EMC with 1.2 M LiPF₆ compared to the baseline electrolyte solutions.

FIGS. 8A and 8B are graphs, showing the discharge cycle capacities as a function of cycle number for cells with FM2 at various concentrations in A) 1:1 EC:DEC with 1.0 M LiPF₆ and in B) 1:2 EC:EMC with 1.2 M LiPF₆ compared to the baseline electrolyte solutions.

FIGS. 9A and 9B are graphs, showing impedance spectra for cells containing 5 wt % phosphazene additives FM2, FM3, and FM4 in A) 1:1 EC:DEC with 1.0 M LiPF₆ and in B) 1:2 EC:EMC with 1.2 M LiPF₆ compared to the baseline electrolyte solutions.

FIGS. 10A and 10B are graphs, showing impedance spectra for cells containing 5 wt % and 20 wt % FM2 in A) 1:1 EC:DEC with 1.0 M LiPF₆ and in B) 1:2 EC:EMC with 1.2 M LiPF₆ compared to the baseline electrolyte solutions.

### DETAILED DESCRIPTION

The following description is not to be taken in a limiting sense, but is made merely for the purpose of illustrating example embodiments.

In example embodiments, additives (also referred to herein as “co-solvents”) that stabilize a conventional organic electrolyte solution are provided.

In certain embodiments, the additive improves the safety and useful life of the lithium ion battery in which it is employed.

In still further embodiments, the flash point of the electrolyte solution is elevated when the additive is added to the solution.

In other embodiments, the vapor pressure of the electrolyte solution is decreased.

According to still further example embodiments, the degradation cascade present in a typical organic solvent is prevented.

In other example embodiments, the electrochemical window of stability is increased.

In further embodiments, the thermal stability of the electrolyte solution is increased when the additive is used.

According to example embodiments, at least one phosphazene-based compound is added to an organic solvent, and the mixture performs better than the organic solvents alone. In further embodiments, the mixture is safer, more stable, and highly resistant to boiling and burning.

In further embodiments, the organic solvent is an organic carbonate solvent. In other embodiments, the organic solvent is an organic ester solvent. In still further embodiments, the organic solvent is a mixture of various organic solvents.

In certain embodiments, the phosphazene-based additives are used in blends with typical organic solvents for use in an electrolyte solution of a rechargeable battery. In still further embodiments, the ionizable salt used in the electrolyte solution is a lithium ion. In further embodiments, the salt is a sodium ion. In still other embodiments, the salt is a magnesium ion. In further example embodiments, the salt is a mixture of various ionizable salts.

According to certain embodiments, the phosphazene-based compounds are used as additives and co-solvents in blends with typical carbonates for use in lithium ion batteries.

According to further embodiments, a series of chemically-similar fluorinated cyclic phosphazene trimers with varying numbers of fluorinated pendant groups are used as additives and co-solvents in blends with typical organic solvents for use in rechargeable batteries.

In some embodiments, this series of compounds is prepared by the nucleophilic substitution of the reactive chlorines on hexachlorocyclotriphosphazene with ethoxy or 2,2,2-trifluoroethoxy groups.

According to example embodiments, the number of ethoxy and 2,2,2-trifluoroethoxy groups are varied, as shown in Table 1 below:

TABLE 1

| Designation | 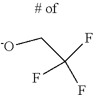 | 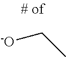 | Average Molecular Weight (g mol⁻¹) | Density (g ml⁻¹) |
|---|---|---|---|---|
| FM1 | 6 | 0 | 729.13 | n.d.* |
| FM2 | 3 | 3 | 567.22 | 1.33 |
| FM3 | 2 | 4 | 513.25 | 1.28 |
| FM4 | 1 | 5 | 459.27 | 1.29 |

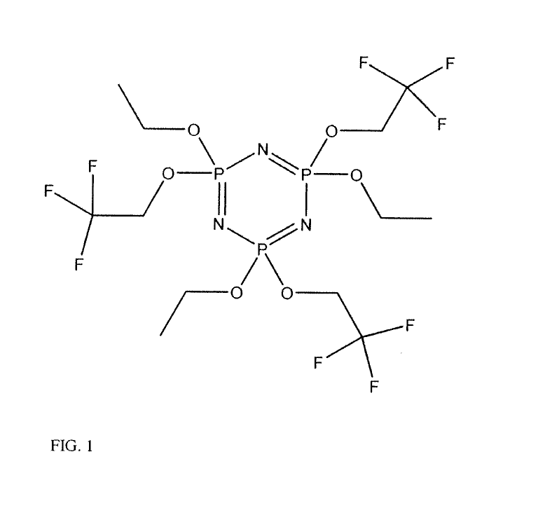

With reference to the drawings attached hereto, FIG. 1 shows the structure for FM2, as an example embodiment.

The representative formulations described in Table 1, are used as additives in a battery solvent, though those of skill in the art will appreciate that many other formulations are possible and will still fall within the scope of this disclosure. For example, according to certain embodiments, pendant groups comprise longer and/or shorter chains.

According to example embodiments, compared to other organophosphorous compounds and other additives, phosphazenes show the least degradation in battery performance.

In further embodiments, low molecular weight phosphazenes are used as additives and co-solvents in batteries. In still other embodiments, fluorinated cyclic phosphazene trimers are used as additives and co-solvents in batteries.

In yet other embodiments, combinations of fluorinated cyclic phosphazene trimers with other phosphazene solvents are used as additives and co-solvents in lithium ion batteries.

Still other embodiments employ a single, or in other embodiments, multiple cyclic phosphazene compounds as a solvent in electrolyte solutions for non-lithium electrochemical systems, including but not limited to sodium and magnesium-based cells.

In further example embodiments, when used in admixtures with conventional electrolyte solvents, the combined electrolyte solvent becomes self-extinguishing. Since electrochemical interaction between the lithium ion and the phosphazene core is diminished, the battery in which the combined electrolyte solvent is encapsulated, according to certain embodiments, performs better than a similar battery encapsulated with only organic carbonate solvent(s).

### Synthesis of Phosphazene-Based Compounds

In one embodiment, an organic aprotic solvent, such as 1,4-dioxane, is mixed with alkali metals or alkali metal hydrides to form reactive alkoxides from their corresponding alcohols. According to example embodiments, a trimer solution is added to the reactive alkoxides, and the resulting compound self-assembles, forming a phosphazene-based compound with a by-product of sodium chloride.

According to example embodiments, a method for preparing phosphazene-based compounds uses the trimer hexachlorocyclophosphazene (i.e., (NPCl₂)₃).

In an example embodiment, the trimer is sublimed prior to use. In various other embodiments, the trimer is not sublimed prior to use.

In another embodiment, anhydrous ethanol, trifluoroethanol (TFE), and 1,4-dioxane are used to prepare the phosphazene-based compounds.

In a further embodiment, the reactions are performed in oven-dried glassware under an atmosphere of dry nitrogen gas.

In yet another embodiment, the reactions are performed using Schlenk techniques.

According to example embodiments, during the synthesis of the phosphazene compounds described below, the reaction progress is followed by ³¹P NMR using a Bruker Avance III 600MHz spectrometer. To ensure the materials are dry, titrations are performed using a Mettler Toledo C30 Karl Fischer coulometer (in an argon glovebox). To ensure the samples are halide-free, samples are analyzed by ion-chromatography with a conductivity detector.

A method of synthesizing one example embodiment of a phosphazene-based compound (FM2) is described below:

### Flask A—Synthesis of an Alkoxide Solution, Sodium Ethoxide (C₇H₅O⁻Na⁺)

In one example embodiment, an oven-dried 1L 3-neck flask is fitted with a dry nitrogen inlet connected to one neck; a reflux condenser connected to the second neck; and a rubber septa fitted to the third neck. The dry nitrogen outlet is fitted to the top of the reflux condenser and passed through a bubbler filled with about 2 inches of silicon oil.

The flask is kept under a slow steady stream of dry nitrogen until completion of the reaction. The flask is filled first with about 700 ml of anhydrous dioxane (C₄H₈O₂, an organic aprotic solvent and stabilizer used to prevent the degradation of the solvent). Then, about 9.92 grams of sodium metal (Na) (about 0.431 moles) is added. To this mixture, an about 60% excess of anhydrous ethanol (C₂H₅OH) (e.g., about 40 ml, about 0.685 moles) is added to form a reactive alkoxide from its corresponding alcohol. The reaction is then heated at nearly reflux temperature until all or nearly all of the sodium is consumed.

### Flask B—Synthesis of Sodium Trifluoroethoxide (C₂H₂F₃O⁻Na⁺)

In a further embodiment, an oven-dried 2L 3-neck flask is fitted with a dry nitrogen inlet connected to one neck; a reflux condenser connected to the second neck; and a rubber septa fitted to the third neck. The dry nitrogen outlet is fitted to the top of the reflux condenser and passed through a bubbler filled with about 2 inches of silicon oil. The flask is kept under a slow steady stream of dry nitrogen until the completion of the reaction.

The flask is filled first with about 700 ml of anhydrous dioxane (C₄H₈O₂). Next, about 11.3 grams (about 0.49 moles) of sodium metal (Na) is added. Then, about 35.7 ml (0.49 moles) of TFE (CF₃CH₂OH) is added to form a reactive alkoxide from its corresponding alcohol. In example embodiments, the TFE is added slowly or in steps to prevent an uncontrolled electrochemical reaction. The reaction is then heated at nearly reflux temperature until all or nearly all of the sodium is consumed.

Flask C—Preparation of Phosphazene Solution, Hexachlorocyclophosphazene Solution (i.e., Trimer (NPCl₂)₃)

In yet another embodiment, an oven-dried 500 ml flask containing about 50 grams of trimer is dissolved in about 300 ml anhydrous dioxane.

Preparing the Phosphazene-Based Compound

In an example embodiment, the trimer solution from Flask C is added to the sodium ethoxide in Flask A under nitrogen at room temperature, and then heated at sub-reflux for around five (5) hours, with the reaction progress being monitored by ³¹P NMR.

In further example embodiments, the resulting solution is then cooled to room temperature and added to the contents of Flask B described above, which contains sodium trifluoroethoxide at room temperature under nitrogen. The solution is then heated to sub-reflux for around 5 hours. This reaction is also monitored by ³¹P NMR.

According to example embodiments, when the reaction is complete, the solution is allowed to cool to room temperature and excess ethoxides are quenched with water.

According to further embodiments, the solution is neutralized with 2 M HCl.

In further embodiments, the solution is then rotovaped down, leaving the phosphazene-based compound (a liquid) and undissolved solid sodium chloride.

In example embodiments, the product is then decanted off the salt, and taken up in dichloromethane and washed with nanopure (18 MΩ cm) water in a separatory funnel about six (6) times to remove all trace impurities.

According to further embodiments, the dichloromethane is removed from the product by means of drying on a rotary evaporator, and then the product is dried in an argon-purged vacuum oven for several days, with the atmosphere being refreshed with ultra-high purity (UHP) argon daily. The product is then analyzed for Cl⁻ by ion-chromatography, and for water using Karl Fisher titration.

While one method of synthesizing a phosphazene based compound (FM2) is disclosed above, those with ordinary skill in the art recognize that other methods are contemplated herein.

Furthermore, as is seen through the above-described example embodiment, the resulting pendant ligands are dependent upon the reactant selected for substitution onto the cyclic phosphazene. The selection of ethanol and TFE results in alternative pendant groups and/or mixed pendant groups. Different reactant selection results in different pendant groups, for example, other alkoxides are used, or mixed with the provided alkoxides, in alternative embodiments.

In still further embodiments, halogens other than fluorine are used in the pendant groups.

Further example embodiments include ionic liquids with a cyclic phosphazene core. In certain embodiments, a pyridinium group terminates the pendant group, with a difluoromethylene group preceding the pyridinium group.

In further embodiments, the resulting product (i.e., the additive) is added to the organic carbonate solvent to stabilize the electrolyte solutions. This electrolyte solution is then added to the lithium ion battery.

In some embodiments, the additive comprises from about 1% to about 30% of the total weight of the electrolyte solvent. In further embodiments, the additive comprises about 20% of the total weight of the electrolyte solvent.

According to example embodiments, the additive is used in lithium ion batteries for personal electronics. In further embodiments, the additive is used in lithium ion batteries in large strings to operate vehicles or for electrical grid energy storage.

Coin Cell Construction and Testing

According to further embodiments, the physical and electrochemical properties of the electrolyte solutions (with and without the additives) are characterized, and then the blends are used to build 2032-type coin cells which are evaluated at constant current cycling rates from C/10 to C/1. The performance of the electrolyte solutions is measured by determining the conductivity, viscosity, flash point, vapor pressure, thermal stability, electrochemical window, cell cycling data, and the ability to form solid electrolyte interphase (SEI) films.

According to certain embodiments, cells are constructed using a G8 (Conoco-Phillips) graphite based anode and a blended LiₓMn_{y}O₄+Li_{1.1}Ni_{0.33}Mn_{0.33}Co_{0.33}O₂ cathode, where “x” and “y” are generally assigned values greater than 1.0. The geometric area of each electrode is 1.43 cm². A Celgard 2325 separator (1.58 cm²) is used to separate the electrodes.

In certain embodiments, electrolyte solutions containing the fluorinated phosphazenes, alkyl carbonate solvents, and LiPF₆ are prepared in an argon glovebox where the conductivity and viscosity are determined. The reported conductivities are the average of ten measurements obtained on a TOA CM-30R conductivity meter. The viscosities of the blends are determined using a Cambridge DL-4100 (falling bob) viscometer (average of 10 measurements).

According to example embodiments, a portion of the sample is passed out of the glovebox, where the flash point and vapor pressure are determined. Closed-cup flashpoints are determined using a Setaflash 82000-0 (electric ignition) using a ramp determination method. Vapor pressures of the samples are determined from 15° C. to 60° C. in 1° C. increments using a Grabner Instruments Minivap VPXpert vapor pressure analyzer.

In further embodiments, thermal stability experiments are run in an ESPEC BTU133 thermal chamber.

According to example embodiments, carbonate-based electrolyte solutions are chosen for comparison, the first is 1:1 (wt/wt) EC: DEC with 1.0 M LiPF₆ (baseline A), and the second baseline blend is 1:2 (v/v) EC: EMC with 1.2 M LiPF₆ (baseline B). Blends of these baseline electrolytes containing various concentrations of up to 30 wt % of the fluorinated phosphazenes were prepared individually, taking care to keep the overall LiPF₆ concentration constant (at either 1.0 M or 1.2 M, respectively).

According to example embodiments, the viscosities of the electrolyte solutions containing the fluorinated phosphazines were higher than baseline A and baseline B.

In further embodiments, the overall conductivity decreases with increase in the phosphazene loading, and is primarily due to the direct influence of increased viscosity.

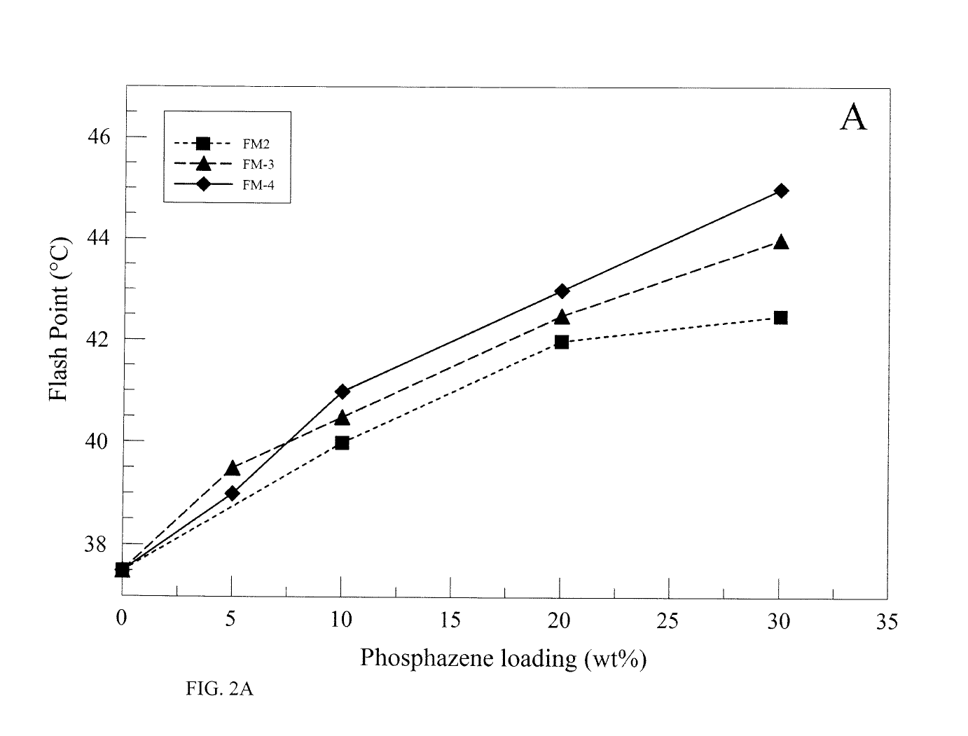

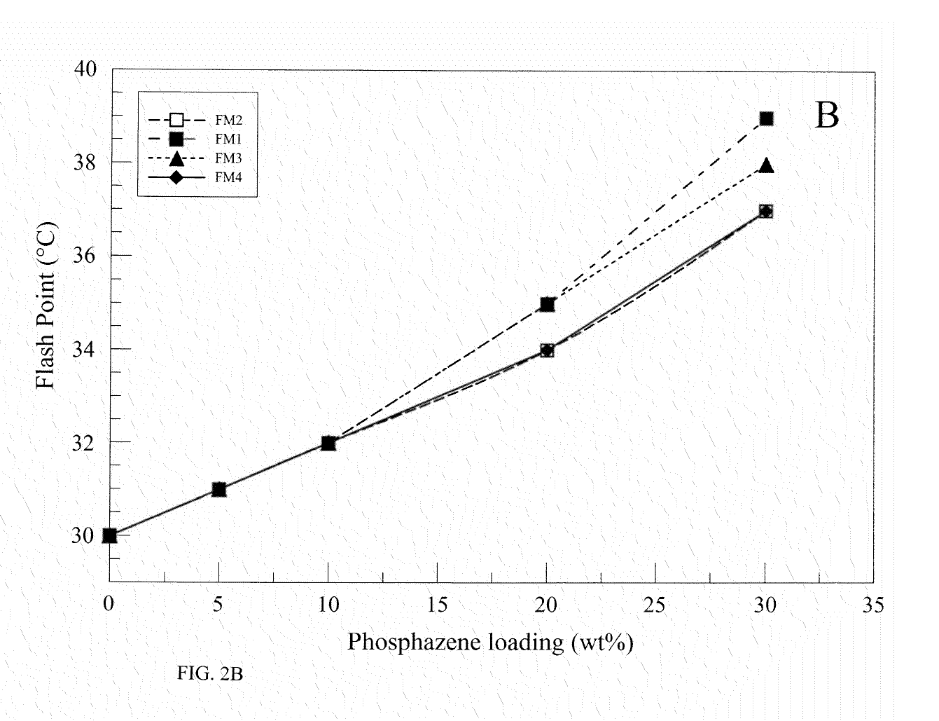

In further example embodiments, after conductivity and viscosity measurements are determined, samples of the electrolyte solutions are passed out of the glovebox, and the flash points and vapor pressures are determined. The flash points of the blends are shown in FIGS. 2A and 2B. The baseline A blend had a flash point of 37.5° C. As shown in FIG. 2A, in blend A, the flash point was systematically increased with increased loading of the phosphazene, up to 44.5° C. for the blend with 30% FM4. The effectiveness of the phosphazenes was FM4, followed by FM3, and then FM2. This corresponds to decreasing number of trifluoroethoxy groups on the phosphazene and increasing number of ethoxy groups. In example embodiments, the phosphazenes are interacting with and suppressing the flammability of the more flammable DEC (DEC fp=25° C., EC fp=143° C.) component of the blend.

In further embodiments, the flash point of blend B baseline electrolyte solution is 30° C., which is 1:2 EC:EMC. The flash point for the more flammable component in blend B, the EMC, is 23.9° C. As shown in FIG. 2B, baseline B blend is more flammable than baseline A blend, due to the larger proportion of the more volatile component. The addition of phosphazenes to this baseline electrolyte also showed higher flash points with increasing proportion of phosphazene. For the blends with 30% phosphazene, the flash point increased from 30° C. to 37.0° C. for FM2 and FM4, 38.0° C. for FM3, and 39.0° C. for FM1.

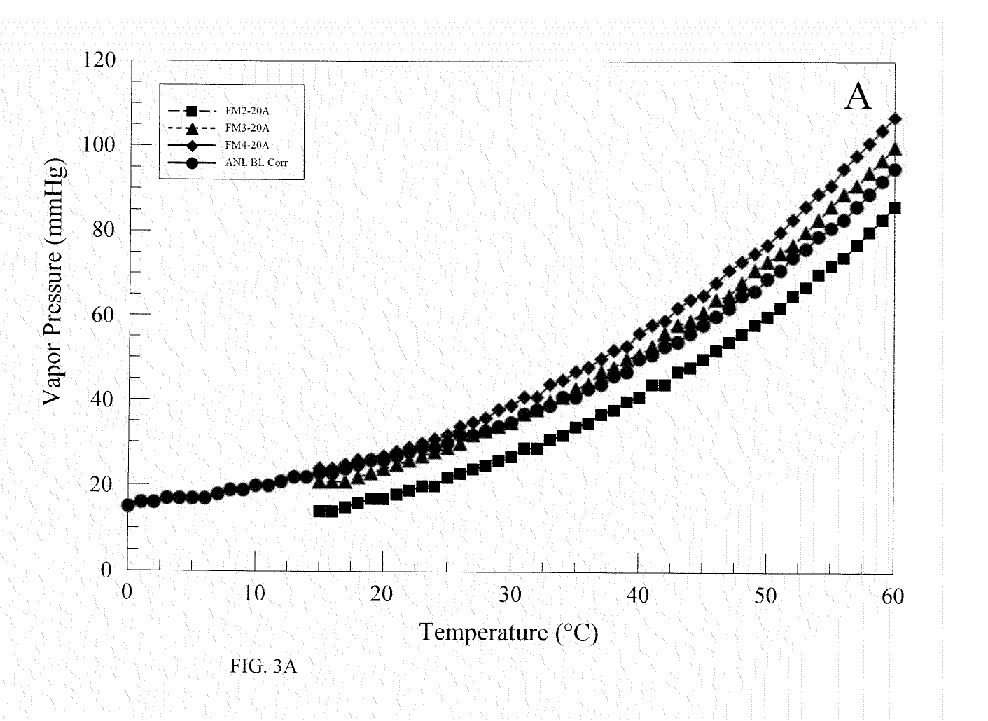

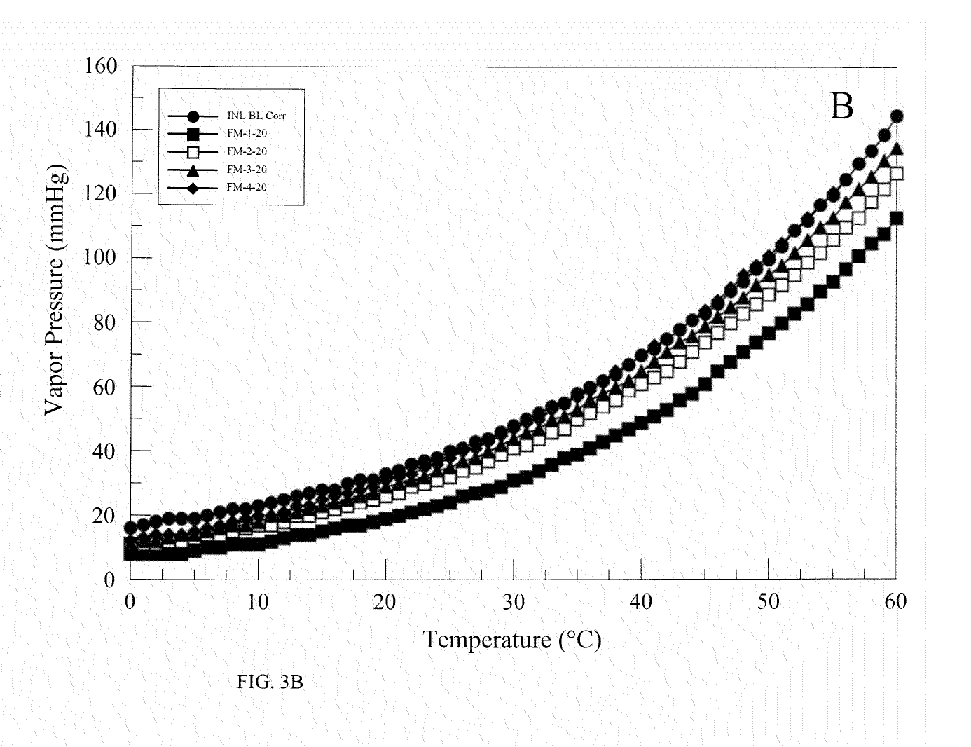

Turning now to FIGS. 3A and 3B, the vapor pressures, as a function of temperature, of the electrolyte blends with the phosphazenes (at 20 wt %) are graphed. As shown in FIG. 3A, for baseline A, at phosphazene concentrations of 20%, the electrolyte blends form two separate liquid phases at low temperature; thus for electrolyte blends in baseline A, vapor pressure measurements are started at 15° C.; for all other samples vapor pressures are determined from 0° C. to 60° C.

According to example embodiments, as shown in FIG. 3A, FM2 depresses the vapor pressure. The vapor pressure for 20% FM3 is nearly identical to the baseline, while for 20% FM4, the vapor pressure is actually slightly higher than the baseline.

As shown in FIG. 3B, the vapor pressures for baseline B blends are higher than the corresponding samples in baseline A, due to the larger proportion of the more volatile component, EMC. According to example embodiments, FM1, FM2, FM3, and FM4 are effective at lowering the vapor pressure compared to the baseline. The vapor pressure of the electrolyte blends followed the order: baseline ≧FM4>FM3>FM2>FM1. As the number of trifluoroethoxy groups on the phosphazene core (and hence the molecular weight of the phosphazene) increases, the vapor pressure of the electrolyte blend decreases.

According to certain embodiments, because the phosphazenes and the ethylene carbonates are relatively non-volatile, the vapor pressures of the blends are proportional to the mole fraction of the volatile component (DEC or EMC for baselines A and B, respectively). According to example embodiments, because the blends are prepared on a weight percentage basis, the number of moles of the phosphazene added varies due to the differences in molecular weight.

Table 1 above displays the molecular weights and densities for each of the tested phosphazene compounds. The mole fraction of each of the components of the blends and the vapor pressure at 30° C. for the 20% phosphazene blends is shown below in Table 2:

TABLE 2

| | Mole Fraction | | | Vapor Pressure |
|---|---|---|---|---|
| | Phosphazene | DEC/EMC | ⁻OCH₂CF₃ | (mmHg) |
| Baseline A | 0 | 0.355 | 0 | 35 |
| FM2 | 0.048 | 0.338 | 0.144 | 27 |
| FM3 | 0.051 | 0.337 | 0.102 | 35 |
| FM4 | 0.057 | 0.335 | 0.057 | 39 |
| Baseline B | 0 | 0.563 | 0 | 48 |
| FM1 | 0.032 | 0.545 | 0.193 | 24 |
| FM2 | 0.049 | 0.536 | 0.146 | 32 |
| FM3 | 0.052 | 0.534 | 0.103 | 35 |
| FM4 | 0.058 | 0.530 | 0.058 | 38 |

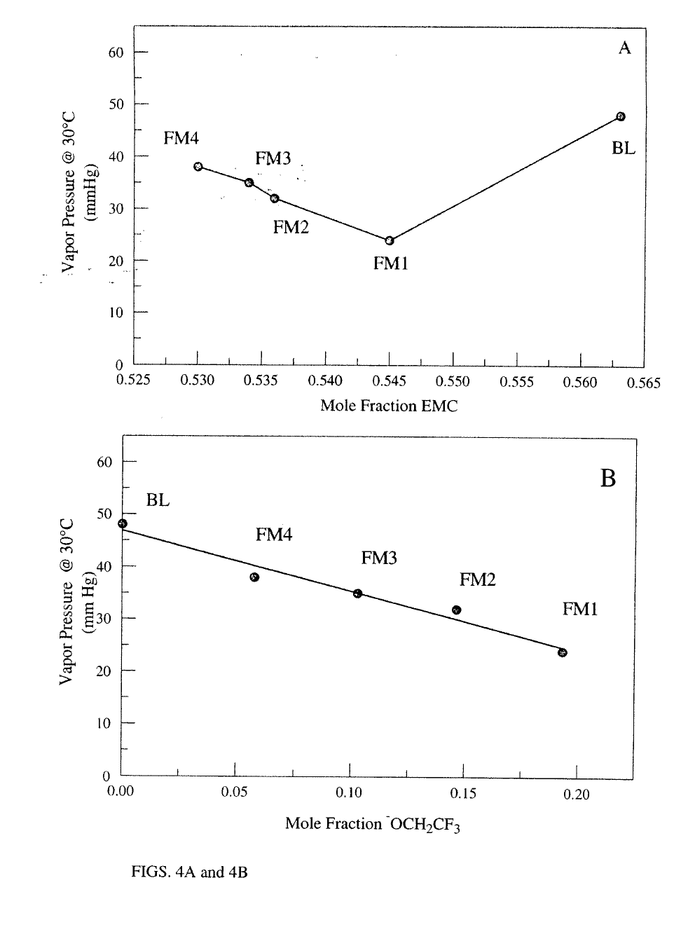

Turning next to FIGS. 4A and 4B, the vapor pressures of the blends (at 30° C.) are plotted versus the mole fraction of EMC (FIG. 4A) and mole fraction of the trifluoroethoxy groups, using baseline B (FIG. 4B). While the baseline has the highest mole fraction of EMC (0.563) and the highest vapor pressure (48 mmHg), the vapor pressures of the blends containing phosphazene decrease with increasing EMC mole fraction. FIG. 4B shows that the vapor pressures of the blends decrease linearly with increasing mole fraction of trifluoroethoxy groups.

According to example embodiments, cyclic phosphazene trimers have negligible volatility and extremely high thermal stability, not undergoing decomposition until approximately 270° C.

In further embodiments, to determine if the FM series of phosphazenes enhances the thermal stability of the blends, a sample of each of the electrolyte blends (in a hermetically sealed vial) are placed in an environmental chamber at 60° C. and periodically inspected. Both of the baseline electrolytes showed visible discoloration within the first 2 weeks. Blends containing phosphazenes initially showed no discoloration (FM2 and FM3) or very little for the case of FM4. By day 42, both of the baseline electrolytes are a deep red and by day 55, they are black, very viscous, with the formation of copious amounts of solid precipitate. The baseline electrolytes show a decreased volume due to the formation of solid precipitates. However, the volume of the samples containing the phosphazenes remains constant throughout the testing.

By day 55, according to certain embodiments, the samples containing phosphazenes show very little if any change, while the baseline blends are solid residues. By day 98, even the blends with the phosphazenes are showing a slight discoloration which becomes more pronounced by day 245.

According to example embodiments, all of the disclosed phosphazenes greatly increased the thermolytic stabilities of the blends for both of the baseline electrolytes; as little as 1% phosphazene is enough to provide this thermal stability. In example embodiments, multidimensional NMR experiments indicate the stabilization is provided by the phosphazenes, due to their ability to act as a free-radical sponge, thus preventing the polymerization of the EC and other carbonate electrolytes.

According to further embodiments, the electrochemical stability of the FM series of phosphazenes (20 wt %) with 80 wt % 1:4 EC:EMC with 1.2 M LiPF₆ is examined. One of the metrics of stability is the electrochemical window (EW). The EW is the potential region were no redox reactions occur in the electrolyte itself. There are a number of methods reported in the literature for determining the electrochemical window; however, all of them are relative and vary based on the assumptions made. The method as described herein is sensitive enough to observe differences in the electrochemical window for each of the phosphazene blends. However, it will be recognized by those with ordinary skill in the art that other methods for determining the electrochemical window are contemplated herein.

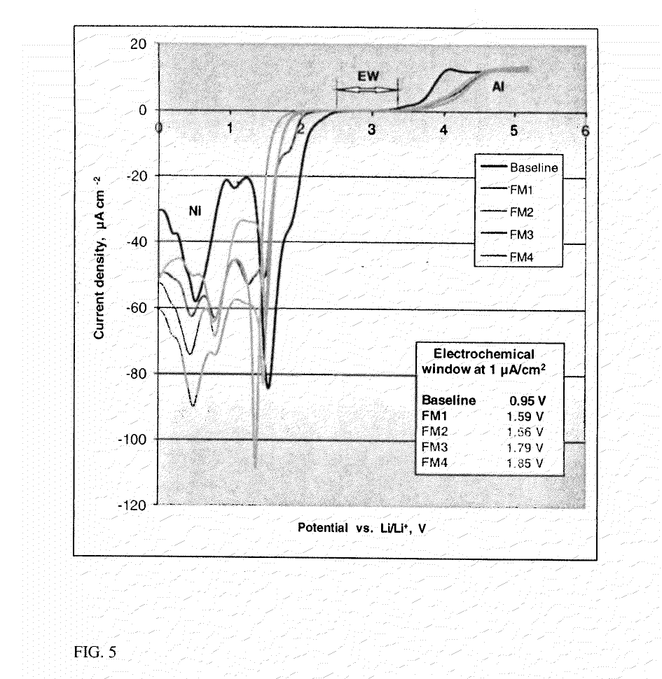

In example embodiments, to measure the EW, two separate potentiodynamic polarizations are done. One polarization used nickel metal foil as the working electrode against lithium counter and lithium reference electrodes at potentials negative to open-circuit voltage (OCV). Another polarization uses aluminum metal foil as the working electrode against lithium counter and lithium reference electrodes at potentials positive to OCV. A combination of potentiodynamic polarization curves, on Ni and Al, on the same potential scale against Li, allows the EW to be estimated for the electrolyte solutions, as shown in FIG. 5. A 1 μA current limit was used as a metric for EW evaluation. The EW for the baseline alone is 0.95 V.

According to example embodiments, addition of each of the phosphazenes increases the EW to as high as 1.85 V, adding nearly 1 V of stability to the electrolyte blend. All of the tested FMs are effective in expanding the EW; however, those with a lower degree of fluorination are more effective.

According to further embodiments, an assessment of phosphazene-based electrolyte solutions in regards to film formation capability (SEI on anode and cathode-electrolyte interface on cathode) is performed. The metrics for the films properties include: film formation capacity, film corrosion rate, film maintenance rate, film kinetic stability and film impedance.

Overall, in example embodiments, all phosphazene varieties improve cathode-electrolyte interface properties. All phosphazene varieties significantly reduce (by more than an order of magnitude) the impedance of SEIs on the anode, demonstrating a benefit for the phosphazene additives. For other SEIs properties, some are improved to different extents; some are not changed or slightly compromised.

In further embodiments, full cell evaluation is performed using CR 2032-type coin cells. Electrolyte blends with baseline A are prepared with each of the FMs with concentrations of 5 and 20 wt %, while blends with baseline B are prepared with FM concentrations of 5, 10, 20, and 30 wt %. Three cells are constructed for each electrolyte blend. The cells are formed at a constant-current C/10 rate for three cycles with a 1 hour rest between each charge and discharge cycle.

According to example embodiments, the state of the cells is evaluated using a reference performance test (RPT) which includes constant-current discharges at C/10, C/3, and C/1 rates, with C/10 charges in between, followed by a 2-hr rest in between each complete cycle.

In certain embodiments, the cells are cycled using C/10 charge rate followed by C/3 discharge rate for 40 cycles before another RPT cycle is run. The cells are cycled for a total of 200 cycles (excluding RPTs).

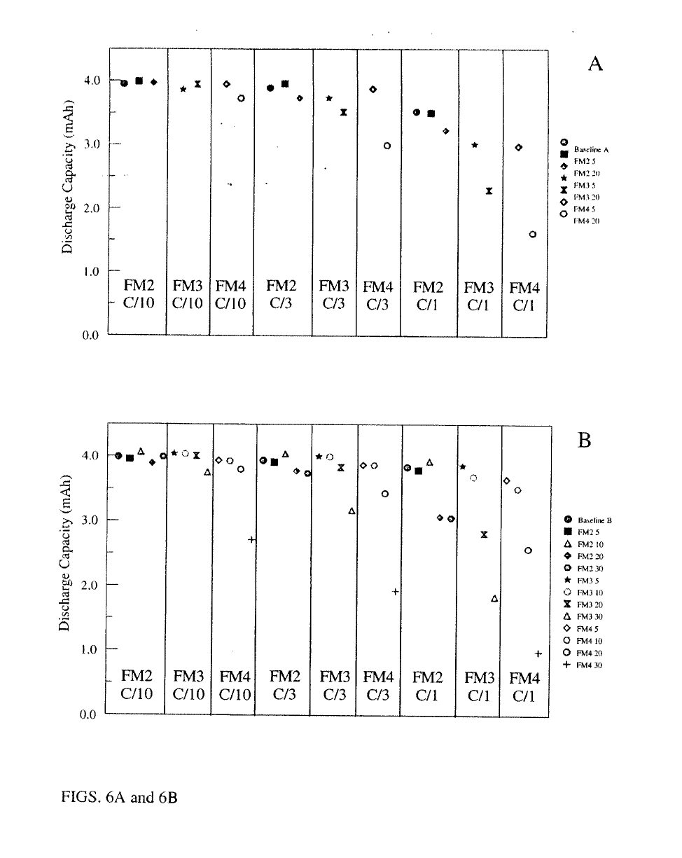

The results of the first RPT performed after cell formation (i.e. beginning of life) are shown in FIGS. 6A and 6B. Each point in the figure is the average of 3 separate cells for each of the phosphazenes and its concentration in both of the baseline electrolytes.

In both of the baselines, at slow discharge rates (C/10) addition of phosphazenes even up to 30% have little impact on cell capacity, with the exception of 30% FM4 in baseline B (FIG. 6B), where the cell capacity is significantly lower compared to other blends with the same phosphazene loading. This effect becomes apparent and more pronounced at higher discharge rates in both of the baselines. The decrease in capacity with higher phozphazene loading and faster discharge rates is most pronounced for FM4, followed by FM3, then FM2. According to example embodiments, FM2 performs as well as (and in some cases better than) the baseline until the highest concentrations and fastest discharge rate are reached (20% and 30% @ C/1).

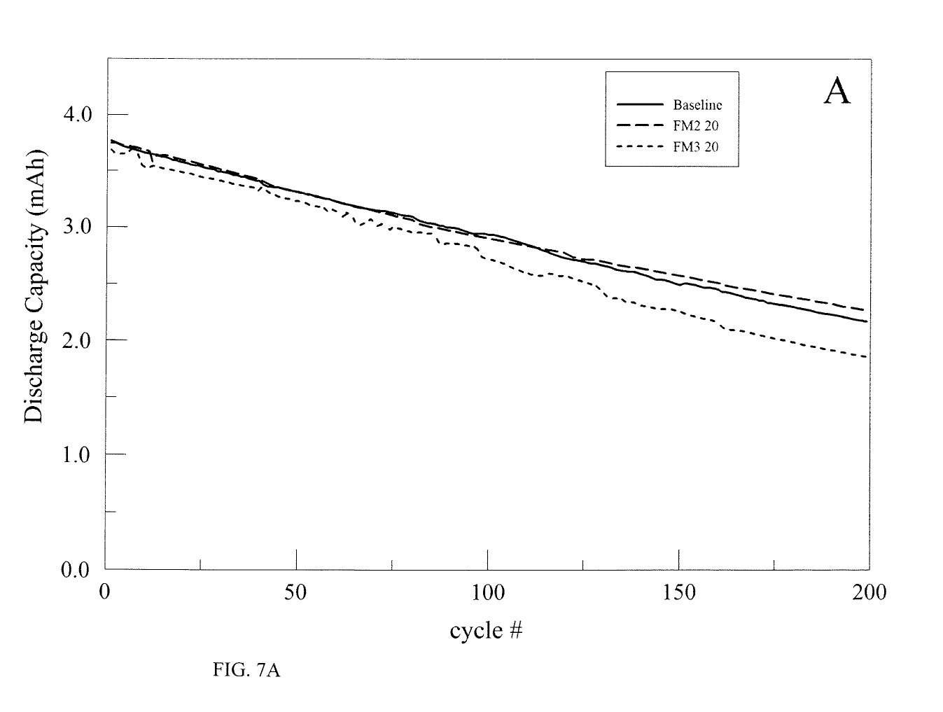

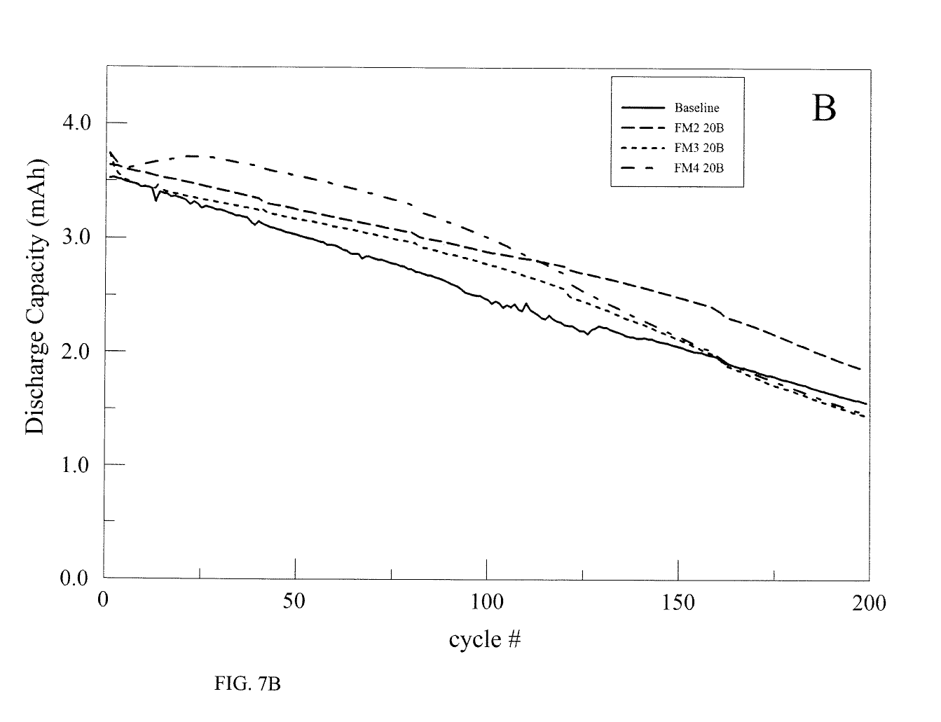

In addition to determining the state of the cells after formation, in example embodiments, the effects of cycle life are evaluated. FIGS. 7A and 7B show the discharge capacities for each of the electrolyte blends containing 20% phosphazene as a function of cycle number. In baseline A, as shown in FIG. 7A, the initial capacities are all very high (˜3.9 mAh). The capacities of the baseline and those with 20% phosphazene are very similar. The blend with FM3 shows a slightly higher capacity fade.

In FIG. 7B, the capacities of 20% phosphazenes in baseline B are shown. All of the blends with the FMs show slightly higher capacities compared to the baseline. FM2 shows the best performance in the FM series, and performs as well as or better than the baselines alone.

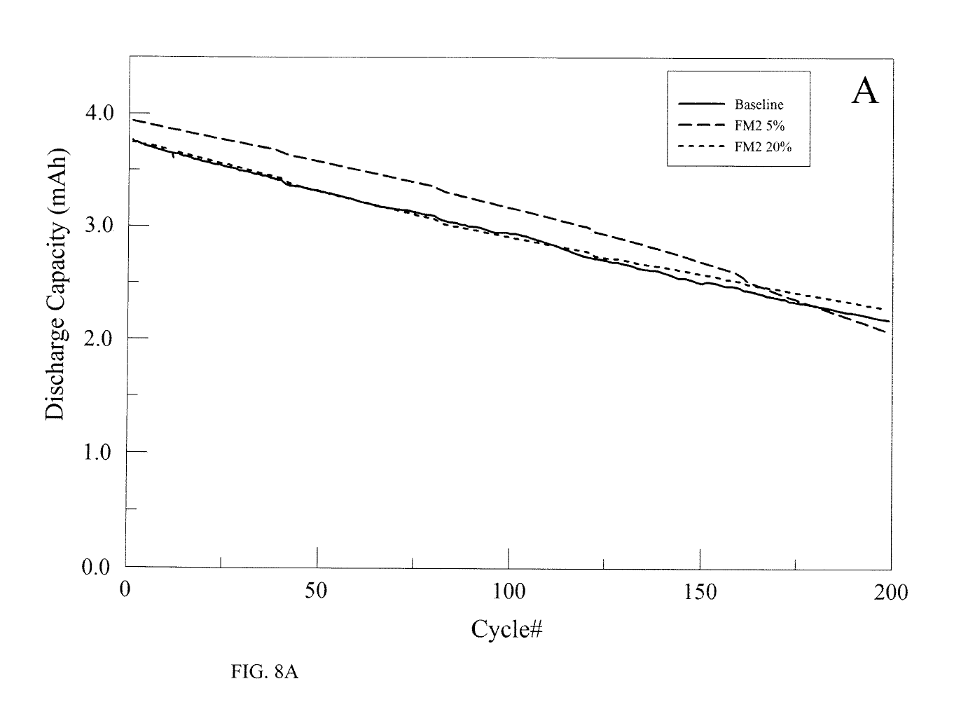

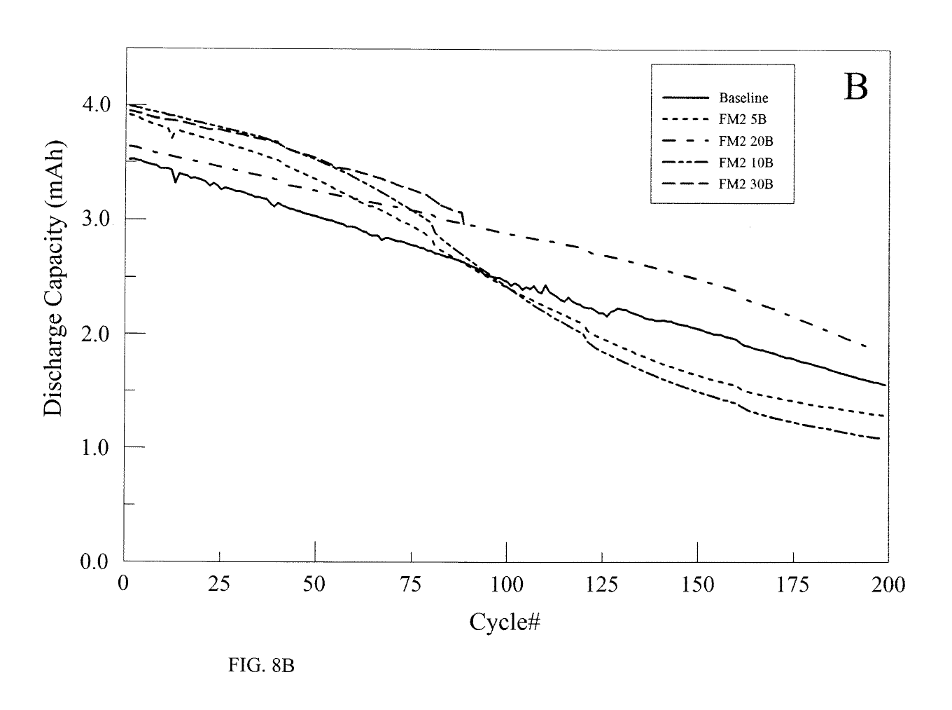

FIGS. 8A and 8B show discharge capacities for blends containing various concentrations of FM2. In baseline A, the 5% FM2 showed the best performance, with discharge capacities superior to the baseline and the 20% FM2 (FIG. 8A). In baseline B, all of the cells with FM2 showed higher initial capacities than the baseline, however there is not a systematic variation (FIG. 8B). After the first about 40 cycles, the rates of capacity fade for the 5, 10, and 30% cells increases. In this baseline, the best performance was from the 20% FM2.

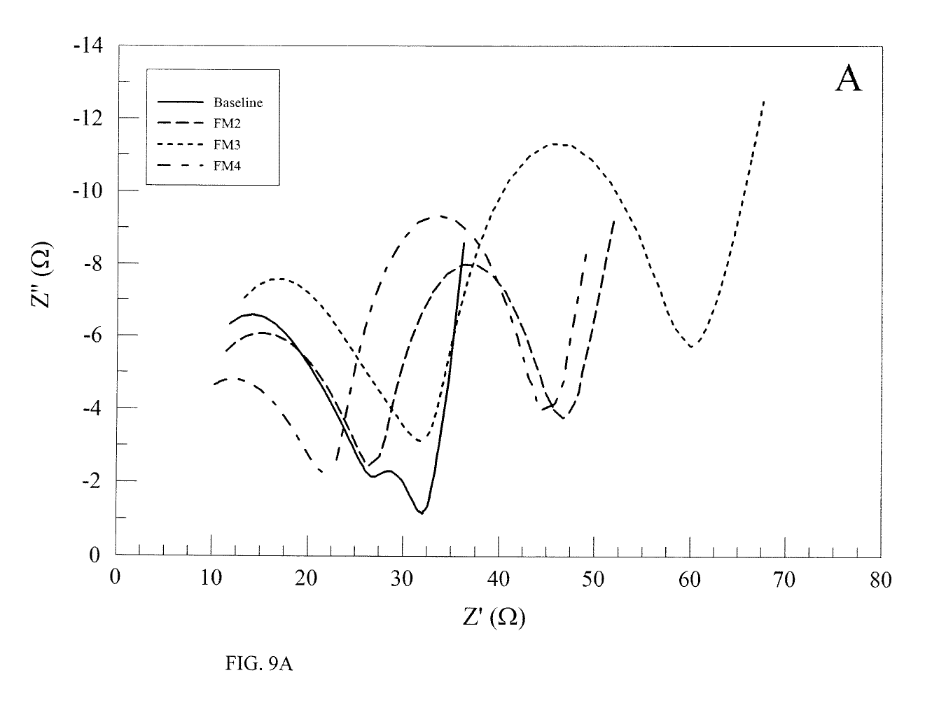

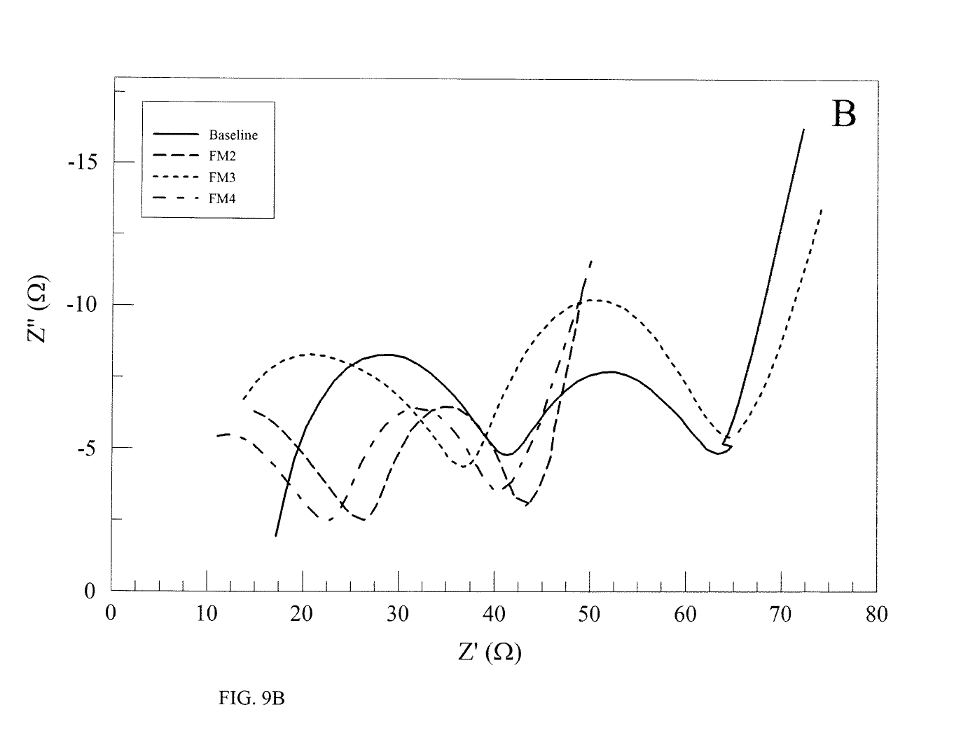

According to example embodiments, to evaluate the properties of the solid electrolyte interphase (SEI), EIS spectra are obtained after cycling the cells for 160 cycles. Analysis of the EIS spectra (FIGS. 9A and 9B) shows key differences and similarities between the two electrolyte systems. The semicircles represent mechanistic processes that influence lithium transport between the free electrolyte region and the solid state domain, that is, the semicircles capture primarily interfacial attributes involving the charge transfer process, influence of SEI traits, and lithium desolvation.

For both baselines, there are changes in the interfacial impedance; where for baseline A the impedance increases (FIG. 9A), but for baseline B the impedance shows a decrease depending on the phosphazene additive (FIG. 9B).

In example embodiments, when comparing the same additive but employing different baselines, it becomes apparent that irrespective of baseline, the interfacial impedance and bulk impedance are uniform for each respective additive. Similar behavior is seen for FM3 and FM4.

According to example embodiments, the interfacial character of the electrode surface films (SEI and cathode electrolyte interphase) is more strongly influenced by the respective phosphazene additives than by the bulk carbonate solvents in the electrolyte.

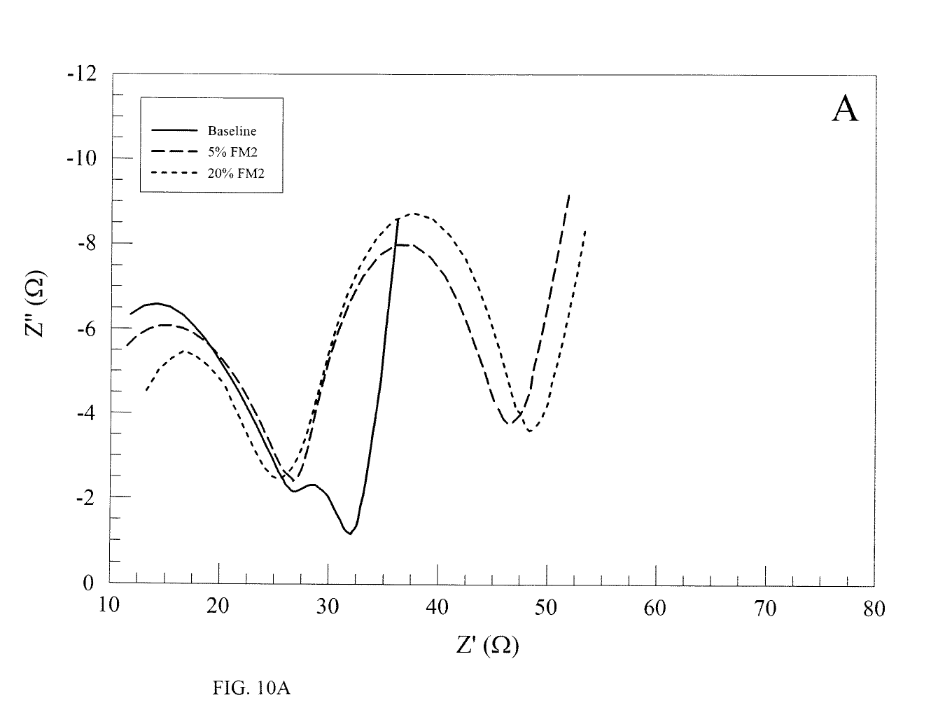

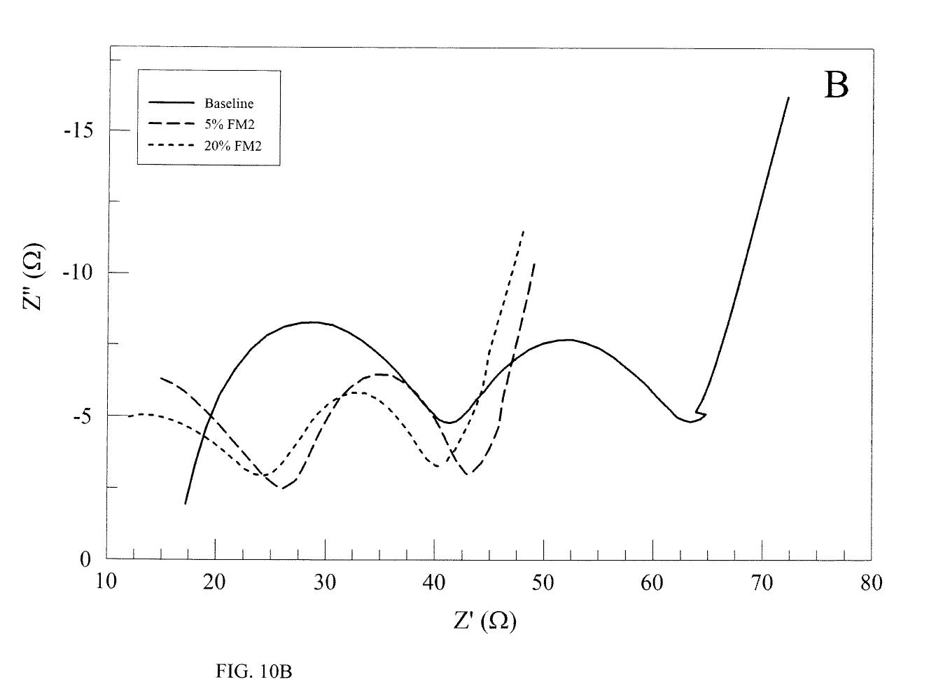

According to further embodiments, comparison of loading level for FM2 (FIGS. 10A and 10B) indicate that loading level does not influence the bulk or charge transfer impedances regardless of baseline.

According to example embodiments, the lack of impedance shift within additive chemistries highlights the utility of phosphazenes as electrolyte additives. Of note is the ability to formulate electrolytes for specific purposes, such as lower viscosity, higher conductivity, decreased flammability and increased Li inventory, without negatively impacting interphase behavior.

In example embodiments, while blends containing the phosphazenes have slightly lower conductivities and slightly higher viscosities, they also have increased flash points and lower vapor pressures.

In further embodiments, the additives increase the thermal and electrochemical stabilities of the electrolyte solutions. In thermal stability testing, not only are the additives themselves stable, but they also prevent the decomposition of the alkyl carbonate solvents.

In addition to increased thermal stability, according to certain embodiments, the additives also increase the electrochemical stability of the alkyl carbonate blend, widening the electrochemical window.

According to further embodiments, in battery cell performance testing on newly formed cells, the additives (up to 30 wt %) showed capacity performance as good as or even better than the baselines at slow cycling rates. At higher rates and at the higher concentrations of phosphazene, the discharge capacities were lower due the higher viscosities and the lower conductivities of these blends. Performance testing over the first 200 cycles of the cells showed the phosphazene samples had higher discharge capacities and showed less capacity fade than the baselines, with FM2 being the best performer. EIS spectra obtained after 160 cycles show the interfacial character of the electrode surface films is more strongly influenced by the respective phosphazene additives than by the bulk carbonate solvents in the electrolyte, thus allowing alkyl carbonate electrolytes to be tailored to optimize specific desired properties without affecting the interphase properties.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will readily appreciate that changes to the description, and various other modifications, omissions and additions may also be made without departing from either the spirit or scope thereof.

1. An electrolyte solution for use in a battery, said electrolyte solution comprising:
an ionizable salt; at least one organic solvent; and at least one cyclic phosphazene compound.

2. The electrolyte solution of claim 1, wherein said at least one cyclic phosphazene compound comprises a halogen.

3. The electrolyte solution of claim 2, wherein said halogen is fluorine.

4. The electrolyte solution of claim 1, wherein said at least one cyclic phosphazene compound comprises at least one fluorinated pendant group.

5. The electrolyte solution of claim 1, wherein said at least one cyclic phosphazene compound comprises at least one 2,2,2-trifluoroethoxy pendant group.

6. The electrolyte solution of claim 5, wherein said at least one cyclic phosphazene compound further comprises at least one ethoxy pendant group.

7. The electrolyte solution of claim 1, further comprising an ionic liquid with a cyclic phosphazene core.

8. The electrolyte solution of claim 7, wherein said ionic liquid further comprises a pendant group, said pendant group comprising a pyridinium group.

9. The electrolyte solution of claim 8, said pendant group further comprising a difluoromethylene group.

10. The electrolyte solution of claim 1, further comprising a fluorinated cyclic phosphazene trimer.

11. The electrolyte solution of claim 10, wherein said fluorinated cyclic phosphazene trimer comprises at least one 2,2,2-trifluoroethoxy pendant group and at least one ethoxy pendant group.

12. The electrolyte solution of claim 1, further comprising an ionizable lithium salt.

13. The electrolyte solution of claim 1, further comprising at least one of an ionizable lithium ion salt, an ionizable sodium salt, and an ionizable magnesium salt.

14. The electrolyte solution of claim 12, wherein said ionizable lithium salt is lithium hexafluorophosphate (LiPF₆).

15. The electrolyte solution of claim 1, further comprising an organic carbonate solvent.

16. The electrolyte solution of claim 15, wherein said organic carbonate solvent is at least one of ethylene carbonate, ethyl-methyl carbonate, and diethyl carbonate.

17. The electrolyte solution of claim 1, further comprising an organic ester solvent.

18. The electrolyte solution of claim 14, further comprising at least two organic carbonate solvents, wherein said at least two organic carbonate solvents are ethylene carbonate (EC) and ethyl-methyl carbonate (EMC) in a 1 to 2 volume ratio of EC to EMC, further wherein the concentration of LiPF₆ is 1.2 M.

19. The electrolyte solution of claim 14, further comprising at least two organic carbonate solvents, wherein said at least two organic carbonate solvents are ethylene carbonate (EC) and diethyl carbonate (DEC) in a 1 to 1 weight ratio of EC to DEC, further wherein the concentration of LiPF₆ is 1.0 M.

20. The electrolyte solution of claim 1, wherein said at least one cyclic phosphazene compound comprises between about 1% and about 30% of the total weight of said at least one organic solvent and said at least one cyclic phosphazene compound.
